(19) United States
(12) Patent Application Publication
(10) Pub. No.: US 2002/0198989 A1
(43) Pub. Date: Dec. 26, 2002

(54) Network terminal retrieval apparatus

(75) Inventor: Shogo Kimura, Tokyo (JP)

Correspondence Address: GREENBLUM & BERNSTEIN, P.L.C., 1941 ROLAND CLARKE PLACE, RESTON, VA, 20191, US

(73) Assignee: Matsushita Graphic Communications Systems, Inc., Tokyo (JP)

(21) Appl. No.: 10/173,609

(22) Filed: Jun. 19, 2002

(30) Foreign Application Priority Data
Jun. 20, 2001 (JP) 2001-186808

(51) Int. Cl. G06F 15/173; G06F 15/00

(52) U.S. Cl. 709/224; 358/1.15

(57) ABSTRACT

A network terminal retrieval apparatus is connected to a plurality of terminal apparatuses via a network. The network terminal apparatus comprises a retrieval condition designator that designate a retrieval condition of the terminal apparatuses, a transmitter that transmits transmission information to request terminal information only relating to items designated by the retrieval condition, to the terminal apparatuses, a receiver that receives response information for the transmission information, a retrieval controller that interprets the response information, and extracts terminal apparatuses with which the response information matches the retrieval condition. Accordingly, a user can obtain only the terminal information relating to the specified retrieval conditions and find only the terminals that match with the retrieval conditions with the obtained terminal information.

### BACKGROUND OF THE INVENTION

1. Field of the Invention

The present invention relates to a network terminal retrieval apparatus that finds an appropriate terminal by obtaining terminal information via a network.

2. Description of Related Art

In a network system where a plurality of terminals and host computers are connected via a network, a search for a terminal with a desired capacity is performed by obtaining terminal information via a network.

In recent years, this type of network terminal retrieval method designates a scope of specific network address, retrieves terminals within the specified network address among all of the terminals in the network, and displays all of the retrieved terminals. Such network terminal retrieval method makes information obtaining requests to each terminal that has the network address specified by the scope. The method then displays terminals having no error in the responding packets among the responding terminals.

Another conventional method in which pre-assumed specific terminal information (e.g., company name) is designated and a terminal installing the specific terminal information is retrieved, has been also used. The retrieval method that compares such terminal information uses a network apparatus monitoring application that periodically obtains terminal information. By employing such a network apparatus monitoring application, terminal information is compared from the obtained information.

However, such a terminal retrieval method that designates a network address cannot specify terminals targeted for the search using the individual terminal information. Although it is possible to compare terminal capacities by receiving the detailed terminal information having the specified network address and displaying the detailed information for each terminal, this method needs to handle detailed information of each terminal. Since the detailed information contains vast terminal information, a terminal searcher is required to conduct a comparison by himself after receiving unnecessary, i.e., redundant information.

In addition, in order to operate an information obtaining application and conduct a search from the obtained information, information irrelevant to the search is also periodically obtained. Therefore, the traffic of communications will increase. Further, since the information is periodically obtained, such information is not always the most recent information.

### SUMMARY OF THE INVENTION

This invention addresses the above-described problems. The purpose of the present invention is to perform a search on network terminals, the search obtaining only necessary terminal information, only with a communication executing the search.

The present invention sets a terminal information obtaining step that obtains terminal information relating only to retrieval conditions specified by a user, for terminals connected via a network, generates transmission information that is converted from the terminal information obtaining step into a format that can be interpreted by the terminals, transmits the transmission information to the terminals, converts response information from the terminals in response to the transmission information, into an interpretable format, and finds terminals wherein a result interpreted from the converted response information matches the retrieval condition.

Accordingly, the user can obtain only the terminal information relating to the specified retrieval conditions and find only the terminals that match with the retrieval conditions with the obtained terminal information.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a block diagram illustrating a network printer system according to an embodiment of the present invention.

FIG. 2 illustrates terminal information relating to printers according to the embodiment of the present invention.

FIG. 3 is a block diagram illustrating a configuration of a network terminal retrieval apparatus according to the embodiment of the present invention.

FIG. 4 illustrates an IP address setting screen according to the embodiment of the present invention.

FIG. 5 illustrates a printer terminal information setting screen according to the embodiment of the present invention.

FIG. 6 illustrates a format of transmission information with which a transmission information generator according to the present embodiment obtains information using the SNMP.

FIG. 7 illustrates a format of reception information received by a receiver according to the embodiment of the present invention.

FIG. 8 is a flowchart illustrating an operation of the network terminal retrieval apparatus according to the embodiment of the present invention.

FIG. 9 illustrates a retrieval result list display screen when a retrieval is performed on printers by the network terminal retrieval apparatus according to the embodiment of the present invention.

FIG. 10 is a content of a user definition according to the embodiment of the present invention.

### DETAILED DESCRIPTION OF PREFERRED EMBODIMENTS

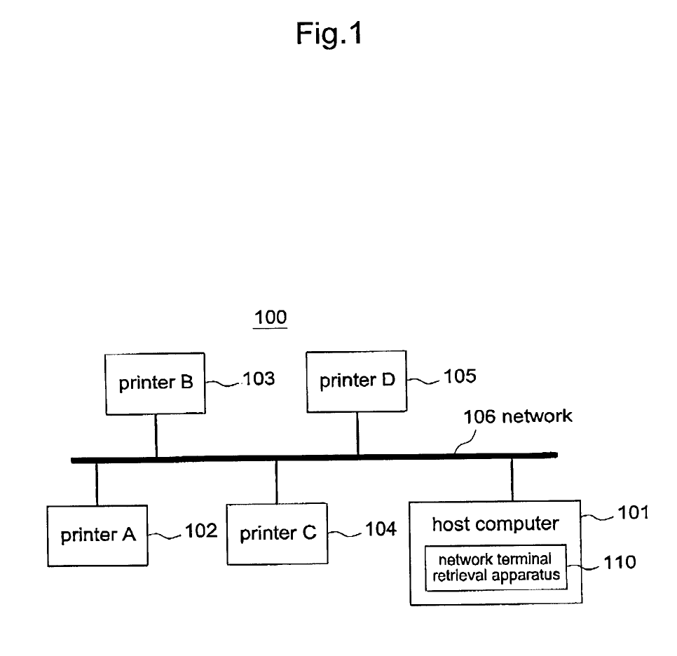

The embodiment of the present invention is explained in the following, by taking a network printer system for example, in reference to the above-described drawings. FIG. 1 is a block diagram illustrating the network printer system according the present embodiment.

In FIG. 1, network printer system 100 according to the present embodiment includes host computer 101 that is connected to printer A102, printer B103, printer C104, and printer D105 via network 106.

Host computer 101 is provided with network terminal retrieval apparatus 110 according to the present invention.

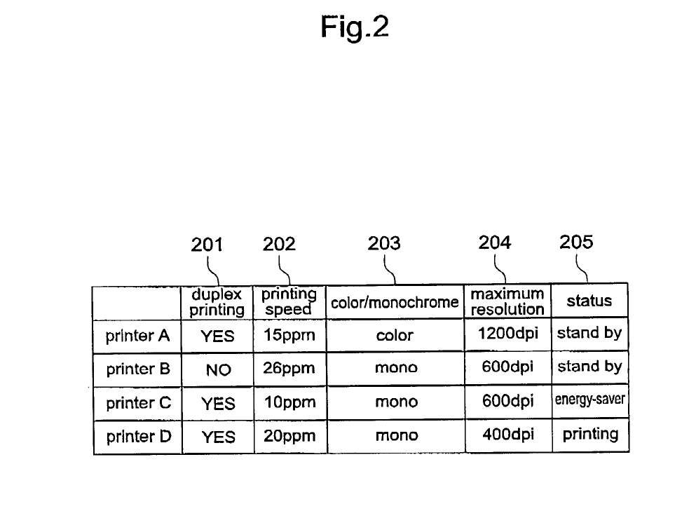

Printers 102-105 have terminal information relating to printers 102-105 respectively as shown in FIG. 2. Terminal information for printers 102-105 include duplex printing capacity information 201 indicating whether the printer can handle duplex printing, print speed information 202, color/monochrome information 203 indicating whether the printer prints color/monochrome, maximum resolution information 204 indicating the printing resolution of the printer, and printer status information 205 indicating operational status of the printer, such as idling energy saving, printing, having printing error, etc.

Terminal information relating to the printers is updated with the newest information according to the printer operation. The printer terminal information can be obtained by network terminal retriever apparatus 110 on host computer 101 via network 106.

Printers 102-105 manage printer terminal information using MIB (Management Information Base).

MIB associates OID (Object Identifier), which is a specific identification number that is pre-assigned to terminal information. When one terminal makes a terminal information request toward another terminal via the network designating an OID using SNMP (Simple Network Management Protocol), the terminal receiving the request retrieves the terminal information associated by the designated OID within the MIB that is owned by the terminal. Then, the terminal receiving the request returns the information back to the terminal that is requesting the terminal information.

By using the above-described system that employs OID, host computer 101 makes a terminal information request directed to printers 102-105 and receives the terminal information from printers 102-105. Further, when host computer 101 makes a terminal information request designating an OID that relates to desired terminal information, host computer 101 is able to receive only the desired terminal information from printers 102-105.

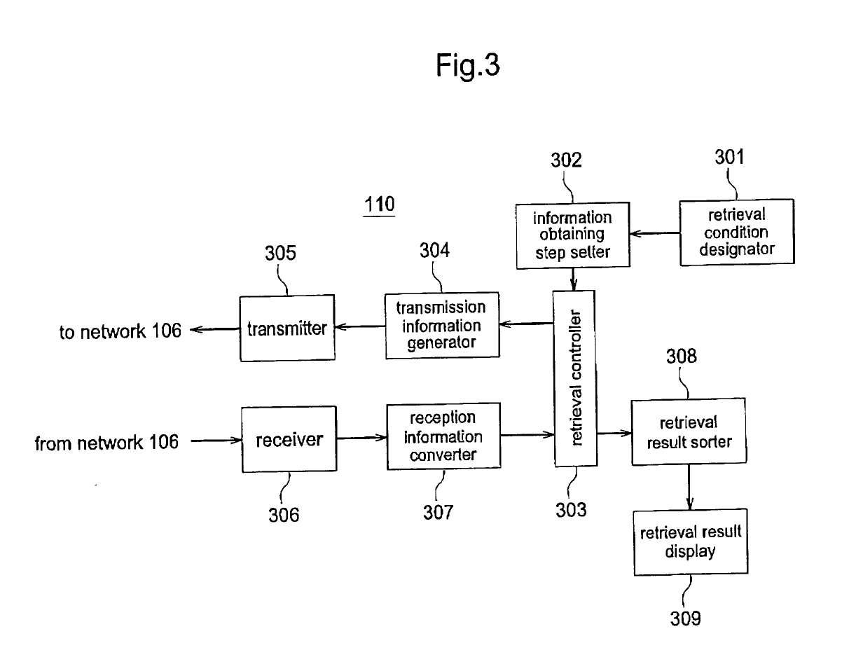

Next, FIG. 3 is used to illustrate a configuration of network terminal retrieval apparatus 110 on host computer 101. FIG. 3 is a block diagram illustrating the configuration of network terminal retrieval apparatus according to the present embodiment.

Network terminal retrieval apparatus 110 includes retrieval condition designator 301 that designates a scope of IP addresses and printer terminal information in order to conduct a search on printers 102-105. Retrieval condition designator 301 displays a screen to designate (set) an IP address and a screen to designate (set) printer terminal information.

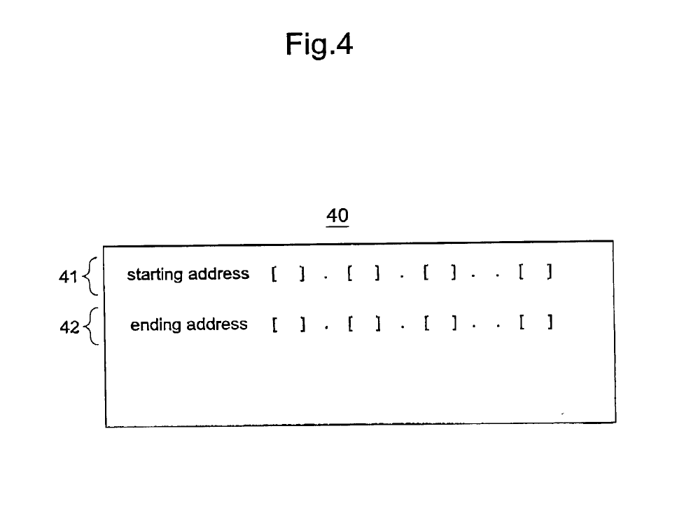

FIG. 4 illustrates the screen setting a scope of IP addresses. IP address setting screen 40 includes area 41 that inputs a starting IP address and area 42 that inputs an ending IP address. A user can designate a scope of IP addresses in order to conduct a search on printers 102-105 by inputting a starting IP address in area 41 and an ending IP address in area 42.

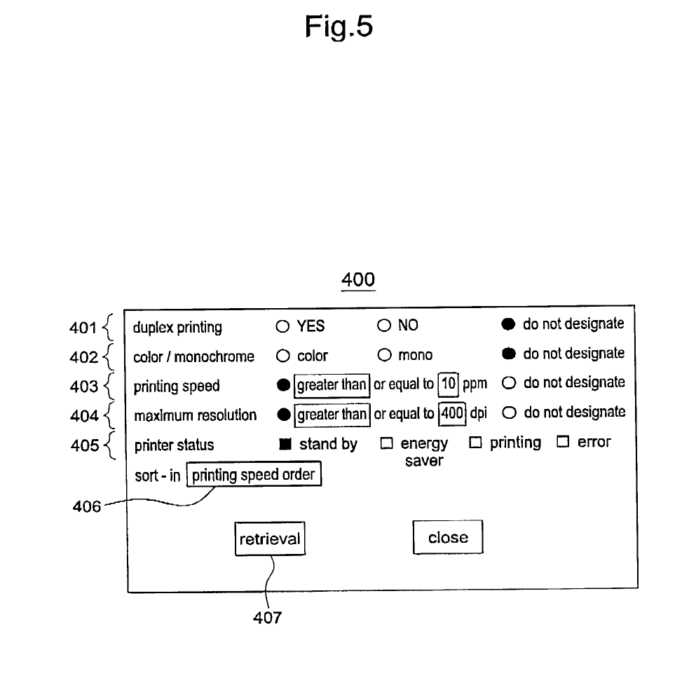

A screen for designating printer terminal information is shown in FIG. 5. FIG. 5 illustrates a printer terminal information setting screen according to the embodiment of the present invention.

Printer terminal information setting screen 400 allows an input of terminal information that printers 102-105 manage using MIB as a retrieval condition. In particular, printer terminal information setting screen 400 displays area 401 designating whether duplex printing is possible, area 402 designating whether color printing is possible, area 403 designating a scope of printing speed, area 404 designating a scope of maximum resolution, and area 405 designating printer status. A user can set a retrieval condition by inputting a desired retrieval condition in areas 401-405.

Also, printer terminal information setting screen 400 include area 406 that allows input of a sorting condition for displaying a list of retrieval results, thereby making it possible to set a display method for the retrieval results. Also, printer terminal information setting screen 400 includes retrieval button 407 that indicates the retrieval execution. When retrieval button 407 is pressed, the printer search is started.

Also network terminal retrieval apparatus 110 includes information obtaining step setter 302 that generates a plan (step) for requesting information toward printers 102-105 on network 106, according to the retrieval condition input by retrieval condition designator 301.

Information obtaining step setter 302 sets an information obtaining step with which terminal information relating to a retrieval condition is requested toward printers 102-105, for every retrieval condition input by retrieval condition designator 301. Also, information obtaining step setter 302 sets a step to request terminal information relating to a retrieval condition in an order of retrieval condition input, when there are a plurality of retrieval conditions input by retrieval condition designator 301.

For example, when a retrieval condition is set as shown in FIG. 5, information obtaining step setter 302 generates steps by first requesting information relating to printing speed, secondly requesting information relating to maximum resolution, and lastly requesting information relating to printer status. When a retrieval condition is input as shown in FIG. 5, information obtaining step setter 302 generates an information obtaining step that does not obtain information relating to duplex printing information 401 and color/monochrome information 402, which are the items with no designation in the retrieval condition. However, information obtaining step setter 302 may generate a transmission plan that obtains information items with no designation in the retrieval condition as backup information.

Also, information obtaining step setter 302 sets steps to determine whether to continue/stop the following communication process from the terminal information sent from printers 102-105, in other words, to determine whether printers 102-105 are terminals targeted for the search. In particular, information obtaining step setter 302 sets a step to stop the following terminal information obtaining process, i.e., communication, when terminal information transmitted from printers 102-105 does not match the retrieval conditions.

In addition, network terminal retrieval apparatus 110 includes retrieval controller 303 that controls transmission/reception according to information obtaining step set by information obtaining step setter 302.

Further, network terminal retrieval apparatus 110 includes transmission information generator 304 that converts the information obtaining step set by information obtaining step setter 302 into a format that can be read by printers 102-105, using an SNMP communication protocol. Transmission information generator 304 may generate a transmission plan that requests information for every input retrieval condition, or generate transmission information that simultaneously requests a plurality of terminal information, since the SNMP can request a plurality of terminal information depending on the size of the terminal information.

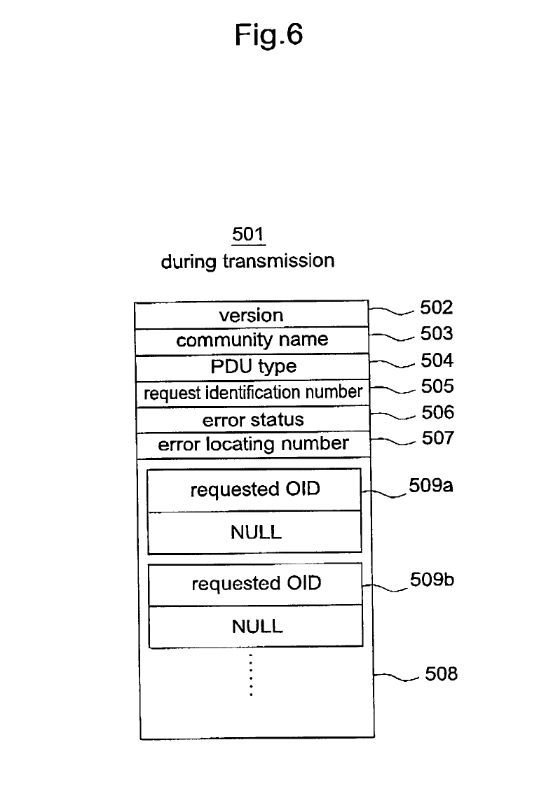

Next, FIG. 6 is used to illustrate a data format of transmission information (packet) for obtaining information, when transmission information generator 304 uses the SNMP. FIG. 6 illustrates a format of transmission information with which the transmission information generator according to the present embodiment obtains terminal information. FIG. 6 illustrates transmission information that simultaneously requests for a plurality of terminal information.

Transmission information 501, which is generated by transmission information generator 304 in order to obtain information from printers 102-105, includes SNMP version information 502, community name 503 that is apparatus identification information set for each apparatus, PDU type 504 that is an area for input of command such as requesting information toward a printer, request identification number 505 that is a reference number for transmission information, error status 506 that indicates whether error has been generated during a communication with printers 102-105, error locating number 507 that indicates a location of an error when the error is generated during a communication with printers 102-105, and requested information 508 that writes information to be requested to printers 102-105 using OID.

PDU type 504 uses Get-Request, a command requesting terminal information written in an MIB to printers 102-105, or Get-Next-Request, a command requesting terminal information following by Get-Request. In particular, when there is a possibility of having a plurality of targeted MIBs, such as terminal information for duplex printing including duplex short length binding, duplex long length binding, and 1 sided printing, such information needs to be obtained by repeating Get-Next-Request 3 times. In such a case, PDU type 504 uses Get-Next-Request. When there is only one MIB, e.g., a name of apparatus, Get-Request is used.

Requested information 508 is assigned using corresponding requested OIDs 509a and 509b for every terminal information requested to printer 102-105, i.e., terminal information relating to retrieval conditions. Also, requested OIDs 509a and 509b are listed so as to correspond to the input order of retrieval conditions that are input from retrieval condition designator 301. In addition, requested information 508 does not have terminal information for requested OIDs 509a and 509b in the initial stage. Terminal information for requested OIDs 509 and 509b are assigned when printers 102-105 responds to the request.

Error locating number 507 indicates a location of an error using the numbers of requested OIDs 509a and 509b.

Transmission information generator 304 encodes transmission information 501 with a format according to the SNMP protocol.

Network terminal retrieval apparatus 110 includes transmitter 305 that transmits a plan converted by transmission information generator 304 to printers 102-105 via network 106, and receiver 306 that receives a response from printers 102-105 via network 106.

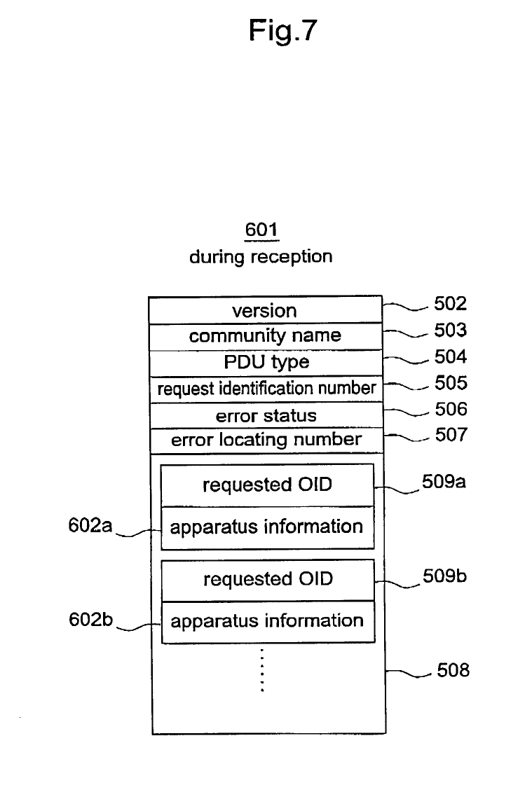

Receiver 306 receives reception information as a response to transmission information 501 transmitted by transmission information generator 304. Hereafter, FIG. 7 is used to illustrate the reception information (packet). FIG. 7 illustrates a format of reception information received by the receiver according to the present embodiment.

Reception information 601 has the same configuration as the transmission information 501 illustrated in FIG. 6. However, PDU type 504 of reception information 601 has Get-Response indicating that it is response information. Also, request identification 505 is the same as the corresponding transmission information 501.

Also, requested OIDs 509a and 509b of requested information 508 are the same as the transmitted transmission information 501, when PDU type 504 of the transmitted transmission information 501 is Get-Request. When PDU type 504 of the transmitted transmission information 501 is Get-Next-Request, requested OIDs 509a and 509b of requested information 508 become OIDs next to the transmitted requested OID.

Contents 602a and 602b of requested OIDs 509a and 509b list terminal information of printers 102-105 (apparatus information) that corresponds to requested OIDs 509a and 509b.

Network terminal retrieval apparatus 110 includes reception information converter 307 that decodes the encoded received information with the SNMP protocol, the reception information being received by receiver 306, extracts requested OIDs 509a and 509b and their contents 602a and 602b, and converts the information into a format that can be interpreted by retrieval controller 303.

Retrieval controller 303 interprets requested OIDs 509a and 509b and their contents 602a and 602b within the received reception information 601, compares the conditions input by retrieval condition designator 301, and extracts printers 102-105 that match the conditions in which the reception information is input. Then, retrieval controller 303 outputs the extracted information of printers 102-105.

Network terminal retrieval apparatus 110 includes retrieval result sorter 308 that sorts printers 102-105, which are extracted by retrieval controller 303, into sorting conditions of the retrieval result, which is input from retrieval condition designator 301. Further, network terminal retrieval apparatus 110 has retrieval result display 309 that displays a list of printers 102-105, which are sorted by retrieval result sorter 308 for the users.

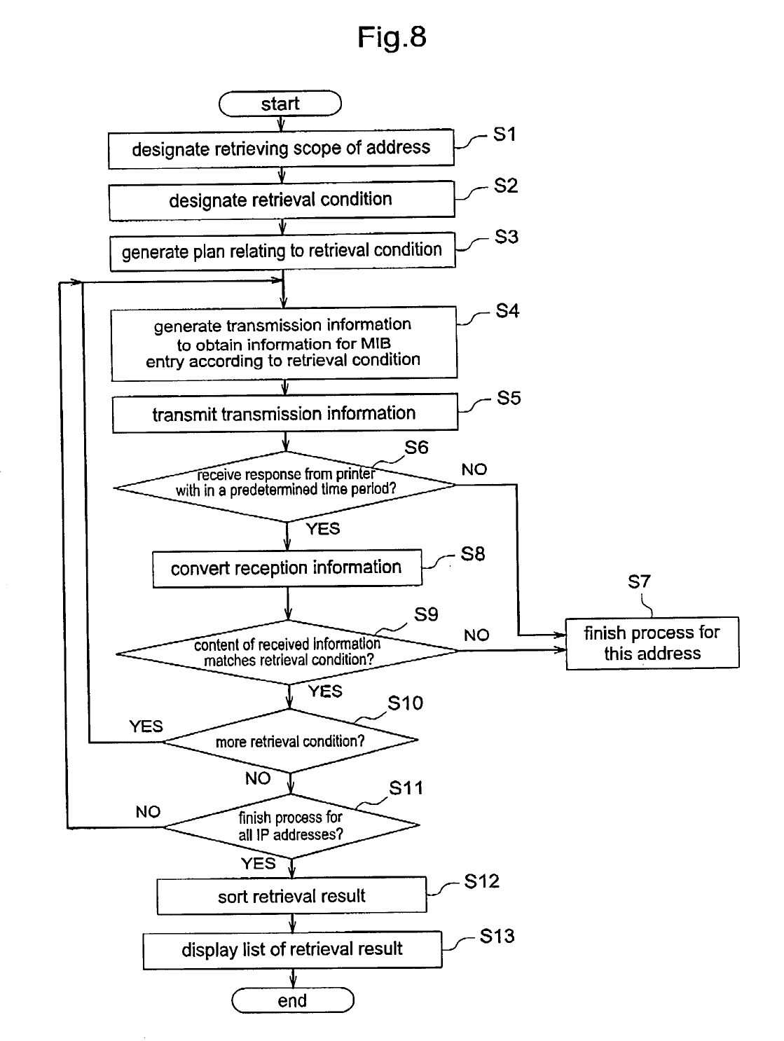

Hereafter, FIG. 8 is used to illustrate an operation of network terminal retrieval apparatus 110 with the above-described configuration. FIG. 8 is a flowchart illustrating the operation of the network terminal retrieval apparatus with the present embodiment.

First, a user designates a scope of IP addresses for retrieving printers 102-105 using retrieval condition designator 301 (step S1; hereafter “step” is omitted). Next, a user opens a printer terminal information setting screen as shown in FIG. 5, and designate a retrieval condition of the retrieving printer (S2). The user also designates a display method for the retrieval result, i.e., sorting order of the display in S2. Accordingly, when the scope of IP addresses and retrieval conditions are set, network terminal retrieval apparatus 110 starts a retrieval operation of printers 102-105.

A user may use a broadcast address instead of designating a scope of IP addresses.

When network terminal retrieval apparatus 110 starts a printer search, information obtaining step setter 302 generates an information obtaining step (plan) relating to the retrieval information that is requested toward printers 102-105, according to the retrieval condition set by the user (S3). Next, transmission information generator 304 generates transmission information (packet) in order to obtain terminal information as shown in FIG. 6, for an MIB entry according to the plan generated by information obtaining step setter 302 (S4). However, transmission information generated here is only for retrieval conditions that can be transmitted in one communication within the input retrieval conditions input at S2. In other words, the generated transmission information here lists only requested OIDs for the terminal information relating to retrieval conditions that can be simultaneously transmitted.

Transmitter 305 transmits transmission information generated at S4 to printers 102-105 having ID addresses set at S1 (S5).

After transmitting the transmission information, retrieval controller 303 waits for a predetermined time period for a response from printers 102-105 to which the transmission information is transmitted at S5 (S6). When there is no response from printers 102-105 to which the transmission information is transmitted at S5, within a predetermined time period, it indicates that printers 102-105 with the transmitted IP addresses do not exist, or that the printers 102-105 do not have a function to communicate using SNMP. Therefore, when there is no response from printers 102-105 to which the transmission information is transmitted at S5, within a predetermined time period, retrieval controller 303 terminates (ends) the information obtaining request process toward the non-responding printers 102-105 with the IP addresses (S7).

When there is a response from printers 102-105 to which transmission information is transmitted at S5, within a predetermined time period, reception information converter 307 converts the received reception information into a format that can be interpreted by retrieval controller 303 (S8).

Then, retrieval controller 303 compares the terminal information included in the converted reception information with the input retrieval condition, and determines whether the terminal information matches the retrieval condition (S9).

When the terminal information received from printers 102-105 does not match the retrieval condition, retrieval controller 302 terminates the information obtaining request toward printers 102-105 of the IP addresses, in order to avoid a meaningless process that obtains further information for other retrieval conditions (S7).

When the terminal information received from printers 102-105 matches the retrieval condition, it is determined whether there are other conditions that were not included in the transmission information at S4 (S10). When there is such a condition, the control returns to S4 and perform the following process.

When the information is obtained for all of the retrieval conditions, retrieval controller 303 waits for a completion of process for all of the IP addresses set at S1 (S11).

Even when there is a response from printers 102-105 to which transmission information is transmitted at S5, within a predetermined time period, if there is an error in response information from printers 102-105, in other words, if an error value is shown in error status 506, the control moves to the process of S7.

When the process for all of the IP addresses set at S1 is complete, retrieval controller 303 extracts printers 102-105 that match the retrieval condition input at S2. Then, retrieval result sorter 308 sorts printers 102-105 that match the retrieval condition in the order set at S2 (S12), and displays the list in retrieval result display 309 (S13).

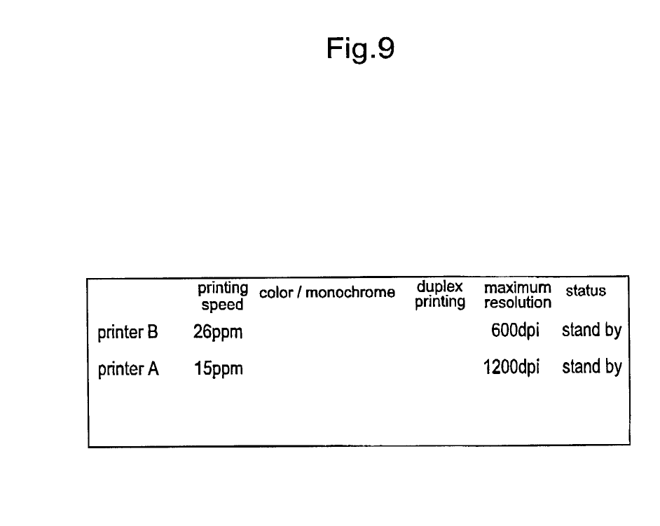

FIG. 9 shows an example of a retrieval result list display screen when a retrieval is performed on printers that have terminal information shown in FIG. 2, with retrieval conditions shown in FIG. 5 (not designating duplex printing, not designating color/monochrome, printing speed being greater than or equal to 10 ppm, maximum resolution being greater than or equal to 400 dpi, choosing only printers in standby, sort in the order of printing speed).

As shown in FIG. 9, printers C and D that are not in standby mode are not displayed. Also, in the present embodiment, retrieval condition items for duplex printing and color/monochrome, which are not designated, are not displayed. As shown in the figure, the list is sorted in the order of what is designated, i.e., in the order of printing speed.

The user may give an instruction to re-sort with a different condition after the list is displayed.

As illustrated above, according to the present embodiment, it is possible to retrieve terminal information relating to only the retrieval conditions set by a user, by retrieving information by generating transmission information that designate an OID of a MIB, corresponding to the terminal information relating to the retrieval condition set by the user, and Get-Request/Get-Next-Request, a command showing a terminal information request as a PDU type, when conducting a printer search via network 106. Accordingly, it is possible to retrieve information by limiting the capacity/status of printers 102-105, using the obtained terminal information of printers 102-105. By obtaining only the terminal information that is necessary for the search on printers 102-105, it is possible to minimize the obtaining terminal information (packet) as a result. Accordingly, a search on printers 102-105 can be conducted effectively. Since the traffic for the communication is decreased, it is possible to lighten the load of communication.

According to the present embodiment, when terminal information cannot be retrieved in one communication for the input retrieval conditions, only terminal information relating to the retrieval conditions that can be transmitted with one communication is retrieved. When the terminal information, a content of reception information retrieved from printers 102-105, does not match with the retrieval condition, the following terminal information is no longer retrieved from printers 102-105. Accordingly, it is possible to avoid retrieving unnecessary terminal information relating to other retrieval conditions. Since the unnecessary communication is no longer continued, traffic is decreased thereby lightening the communication load.

Further, according to the present embodiment, communication is performed only when a user retrieves information from printers 102-105, in order to retrieve necessary terminal information. Therefore, a user can obtain the most updated terminal information without increasing the traffic of communications, since the terminal information is not obtained periodically.

In addition, according to the present embodiment, it is possible to sort the terminal information of printers 102-105 that match the retrieval conditions in a user's desired order, and to display the list. Accordingly, it is possible for users to easily compare printer terminal information and understand the result.

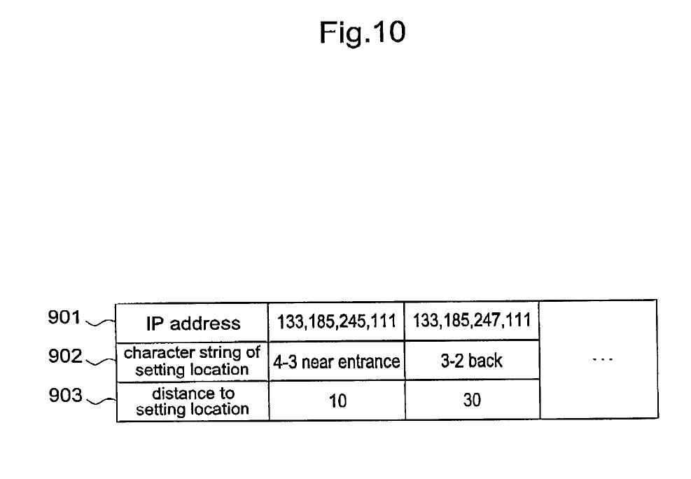

A user may separately input items that cannot be directly retrieved from communication with printers 102-105 (printer location, distance from user's seat, etc.) as retrieval conditions, so that such items are added as user definition and stored in a memory apparatus. FIG. 10 shows an example of a content of user definition to be stored.

As illustrated in FIG. 10, as a user definition, character string of setting location 902 and distance to setting location 903 for printers 102-105 are stored corresponding to IP addresses 901 for printers 102-105. Accordingly, it is possible to display the setting location and compare the distances of printers 102-105.

By using the content of user definition, it is also possible to input character string of setting location 902 and distance to setting location 903 for printers 102-105 as retrieval conditions or sorting condition for the retrieval result at S2 of FIG. 7.

In such a case, character string of setting location 902 and distance to setting location 903 for printers 102-105 are used for retrieval condition, and input character string of setting location 902 and distance to setting location 903 are compared to registered values of user definition, prior to the process of S3. When the real value set by the user definition does not match with the input retrieval conditions, the information is no longer retrieved from IP addresses of the corresponding printers 102-105. When the real value set by the user definition matches with the input retrieval conditions, the retrieval is performed with the same steps described above for the process from S3, and the result is displayed accordingly.

It is still necessary, however, to make an information request after S3 for printers 102-105 with IP addresses that are not pre-registered in user definition by a user in advance, even when the above content is set as a retrieval condition.

As described above, by storing items that cannot be directly obtained in communication with printers 102-105, as a user definition, it is possible to add the items set by user to retrieval conditions, items not having been included in printers 102-105. Therefore, it is possible to improve the retrieval function.

Further, communication is terminated to printers that do not match the retrieval conditions. Accordingly, it is possible to conduct a search with a minimum number of packets that is able to obtain necessary information, and decrease the traffic of communications.

In the present embodiment, printer information retrieval is used as an example. However, this invention is not limited to printer information retrieval, but can be applied to any apparatuses that can obtain information relating to apparatuses from a network, such as a scanner and hub.

Also, this invention also allows an embodiment where processes performed by above-described information obtaining step setter 302, retrieval controller 303, transmission information generator 304, reception information converter 307, and retrieval result sorter 308 are programmed, read and executed by a computer.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based on the Japanese Patent Application No. 2001-186808 filed on Jun. 20, 2002, entire content of which is expressly incorporated by reference herein.

What is claimed is:

1. A network terminal retrieval apparatus connected to a plurality of terminal apparatuses via a network comprising:
a retrieval condition designator that designate a retrieval condition of the terminal apparatuses;
a transmitter that transmits transmission information to request terminal information only relating to items designated by the retrieval condition, to the terminal apparatuses;
a receiver that receives response information for the transmission information, which is transmitted from the terminal apparatuses;
a retrieval controller that interprets the response information, and extracts terminal apparatuses with which the response information matches the retrieval condition.

2. The network terminal retrieval apparatus according to claim 1, wherein when the terminal information cannot be obtained in one communication for the input retrieval condition, only terminal information relating to the retrieval condition that can be transmitted with one communication is obtained.

3. The network terminal retrieval apparatus according to claim 2, wherein when the obtained terminal information does not match with the retrieval condition, following terminal information is no longer obtained from terminal apparatuses.

4. The network terminal retrieval apparatus according to claim 1, wherein the transmission information includes identification number of terminal information corresponding to the retrieval condition and a command indicating information request for the identification number.

5. The network terminal retrieval apparatus according to claim 1, further comprising:
a retrieval result sorter that sorts a list of the terminal apparatus searched by said retrieval controller, by an user's instruction; and
a retrieval result display that displays the list of the terminal apparatus.

6. The network terminal retrieval apparatus according to claim 1, wherein information that cannot be obtained from the terminal apparatuses is pre-stored as an user definition, and the retrieval condition included a content of the user definition;
whereby the information that cannot be obtained from the terminal apparatuses can be set up in the retrieval condition.

7. The network terminal retrieval apparatus according to claim 1, wherein the terminal apparatus comprises a printer.

8. A method for retrieving terminal apparatuses connected via a network comprising:
designating a retrieval condition of the terminal apparatuses;
transmitting transmission information to request terminal information only relating to items designated by the retrieval condition, to the terminal apparatuses;
receiving response information for the transmission information, which is transmitted from the terminal apparatuses;
interpreting the response information, and extracting terminal apparatuses with which the response information matches the retrieval condition.
